(19) United States
(12) Patent Application Publication
(10) Pub. No.: US 2024/0291298 A1
(43) Pub. Date: Aug. 29, 2024

(54) Methods and Apparatuses for Ultra-Portable Battery System Protection and Energy Saving

(71) Applicant: GLF INTEGRATED POWER INC., a Delaware corporation, Fremont, CA (US)

(72) Inventors: Ni Sun, Sunnyvale, CA (US); Stephen W Bryson, Cupertino, CA (US)

(73) Assignee: GLF INTEGRATED POWER INC., a Delaware corporation, Fremont, CA (US)

(21) Appl. No.: 18/657,764

(22) Filed: May 7, 2024

Related U.S. Application Data
(63) Continuation-in-part of application No. 17/129,857, filed on Dec. 21, 2020, now Pat. No. 11,979,041.

(51) Int. Cl. H02J 7/00; H01M 10/44

(52) U.S. Cl. CPC H02J 7/00306; H01M 10/44; H02J 7/00302; H02J 7/00304; H02J 7/00309; H02J 7/0034; H02J 7/0063; H02J 7/0069

(57) ABSTRACT

A fully integrated circuit configuration that can be utilized to prevent abnormal overdischarge and overcharge in ultra-portable electronic systems is described. This battery protection integrated circuit can be enhanced by the addition of traditional battery protection schemes such as current limiting, overcurrent clamping, under voltage lock out and over voltage protection. This battery protection scheme utilizes a high side switch approach utilizing an ultra-low leakage PMOS power switch rather than the traditional low side NMOS switching.

### RELATED APPLICATIONS

This application is a continuation-in-part application of the prior application Ser. No. 17/129,857 filed on Dec. 21, 2020. This application, at least in part, seeks priority to application Ser. No. 17/129,857 with its priority date as that of U.S. Provisional Patent Application No. 62,958,716, filed on Jan. 8, 2020; the entire contents of which are incorporated herein by reference.

### BACKGROUND OF THE INVENTION

### 1. Field of the Invention

Over the past few years, the demand for portability of electronic systems has driven the need for more types and sizes of portable battery systems. In the beginning, these systems were used to power mobile phones, digital cameras, and portable digital assistants (PDA). These battery systems used a variety of battery chemistry devices such as nickel metal hydride, lithium ion, and lithium polymer and could deliver more than 1 A of continuous current. As these systems proliferated, problems with the battery systems arose requiring better control systems to prevent problems such as overcharging, over-discharging or excessive current drawing. The prior art (FIG. 2) of these battery protection systems utilized a multi-chip approach involving discrete NMOS power MOSFET switches and a separate controller chip to handle the large currents and power requirements of these systems. Recently, new ultra-portable systems have emerged including smart watches, fitness trackers and wireless earphones which require a different type of battery delivering significantly less current to the device. These ultra-portable systems require ultra-low current consumption to extend the useful life of the device before needing to be recharged. Into this field has emerged a new type of battery protection system utilizing a completely integrated power switch and battery protection system (FIG. 1) which draws very little current during its operating mode. This new approach utilizes an ultra-low leakage PMOS power MOSFET as the main switch element operating in series with the positive terminal of the battery and directly monitoring the load current through the switch without any sensing resistor. The advantage of this approach is that the battery on the input side can be completely protected through the PMOS switch both from over-discharging as well as from overcharging by having the battery charger connected on the switch output side.

### 2. Prior Art

U.S. Pat. No. 8,674,661: Voltage Switching Circuit, Secondary Battery Protection Circuit, And Battery Pack
U.S. Pat. No. 9,142,283: Battery Protection IC, And Battery Device 3. Summary of the Invention

It is the object of the invention to provide battery control and protection in the following manner. First is to prevent the battery from over discharging when being idle such as in a warehouse or during shipping. In the prior art system shown in FIG. 2, even though the battery minus terminal can be disconnected from the load via the external NMOS switches M1 and M2, the battery remains connected across the VDD and VSS terminals of the control circuit thereby constantly drawing current. In the current embodiment of the invention the power switch remains in the open position until it becomes energized by raising the output voltage above the battery voltage such as would be the case when the output would be connected to a battery charging circuit of say 5V. The battery voltage being nominally between 3.0V and 4.2V. The use of this feature allows the battery to be disconnected from the load normally such as when the initial battery is first connected to the protection circuit. Additional features can be added to improve the battery protection capability of the system. A second embodiment can add an additional overcharging protection circuit thus ensuring that the battery itself cannot be overcharged. A third embodiment of the invention could also add an overcurrent detection circuit which would protect the battery from a load which was outside of the normal operating range of the system. A fourth embodiment could also include a deep sleep function of the battery protection system which would allow the user to manually disconnect the battery from the system load after a specified period of normal operation, such as placing the unit into storage prior to shipment. None of these embodiments are possible using the prior art.

Methods that use the circuits described are also set forth.

### 4. BRIEF DESCRIPTION OF THE DRAWINGS

These and other aspects and features will become apparent to those of ordinary skill in the art upon review of the following description of specific embodiments in conjunction with the accompanying figures, wherein:

FIG. 1 is an overall block diagram of the power PMOS load switch with slew rate control and battery protection functions.

FIG. 2 shows an application of the prior art.

FIG. 3 shows the most basic embodiment of the protection switch.

FIG. 4 shows the typical system application of the present invention where the battery charger IC is connected to the output side of the protection switch rather than directly connected to the battery as in the prior art.

FIG. 5 shows the typical timing diagram of the battery protection device.

FIG. 6 discloses the block diagram of the most basic embodiment of the invention with the Enable, Slew Rate Control, and ODC blocks.

FIG. 7 discloses a further embodiment with the addition of the Over Current Control (OCTC) block.

FIG. 8 discloses a further embodiment with the addition of the Overcharge Control (OCC) block.

FIG. 9 discloses a further embodiment with the addition of the Shipping Mode control block.

FIG. 10 shows the timing diagram used to establish the battery saving feature of shipping mode in the present invention.

FIG. 11 discloses a further embodiment with the addition of Overdischarge Current (ODCT) protection which is added to the Overdischarge block (321), Overcharge Current (OCCT) protection which is added to the Overcharge block (341), and Thermal Shutdown (TSD) protection.

FIG. 12 shows the temperature control performance of the TSD block.

FIG. 13 discloses a further embodiment with an addition of the Reverse Current Control (RCC) block (21).

FIG. 14 illustrates a function of the RCC block (21) structure in a normal charging mode.

FIG. 15 illustrates another function of the RCC block (21) structure in an overcharging mode.

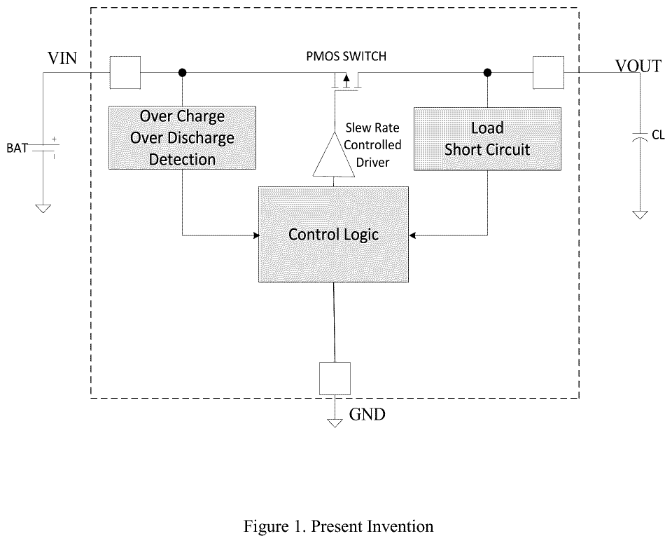

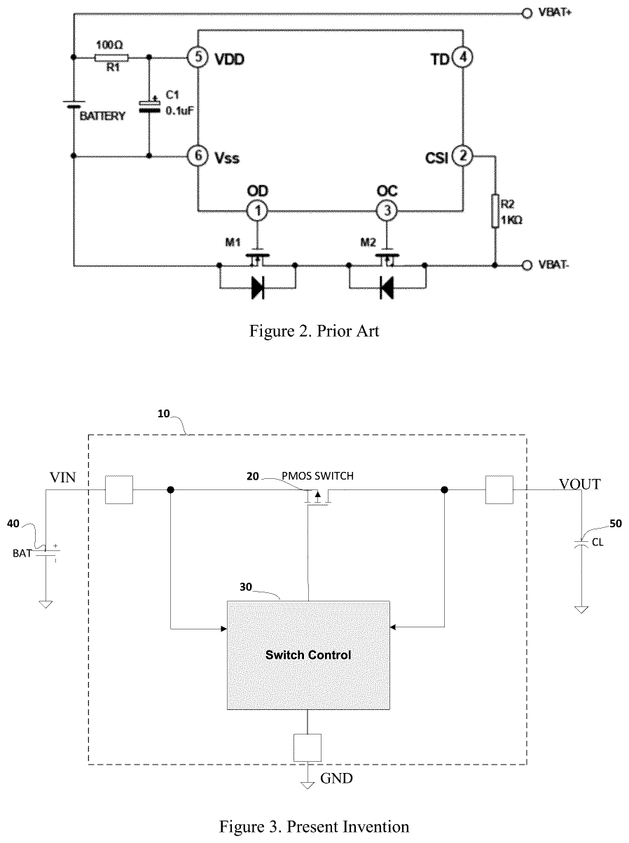

### 5. DESCRIPTION OF THE PREFERRED EMBODIMENTS

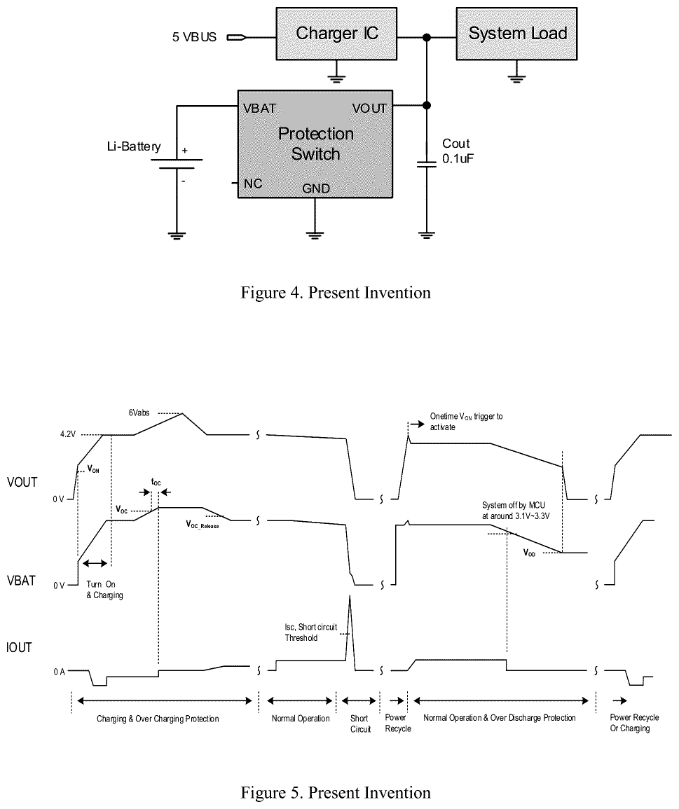

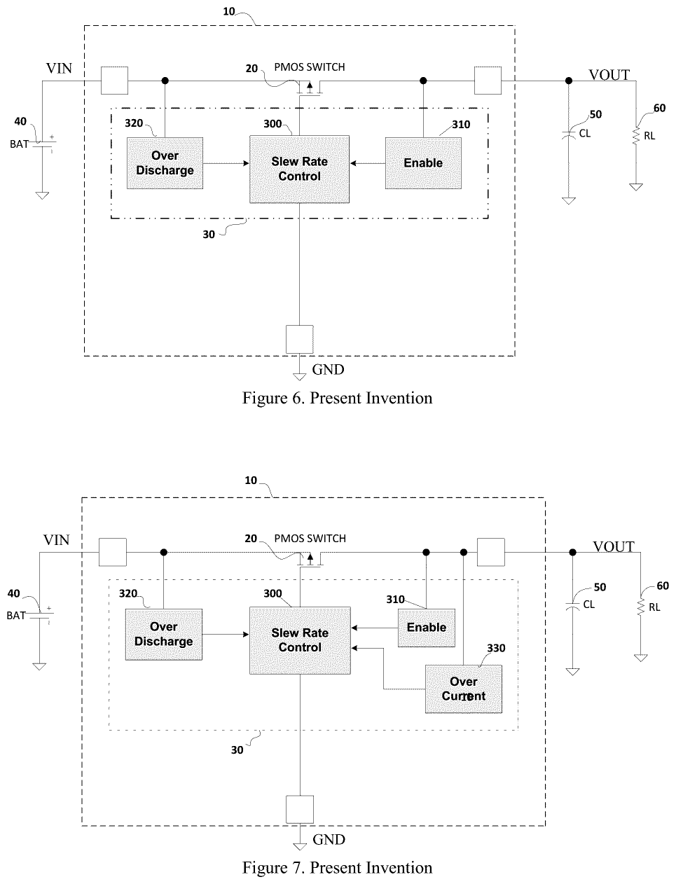

The first embodiment of the present invention is shown in FIG. 6 where (10) is the power protection IC which is designed to provide ODC protection for the portable battery system (40). The design is focused on the power switching PMOS transistor (20) and the switch control system (30). The switch control system is designed to protect the battery in several ways. Firstly, the slew rate control (300) is designed to provide slow rate of voltage rise from the VIN terminal which is connected to the battery power source (40) and to the load connected at the VOUT terminal. The load generally consists of a load capacitance (50) and a load resistance (60) which will cause current to flow from VIN to VOUT while the PMOS power switch (20) is being turned on. If the flow of current from VIN to VOUT is not carefully controlled, either the battery delivering the current or the output receiving the power could be seriously damaged. Allowing too much current to flow during the turn on time of the PMOS switch could needlessly discharge the battery causing the VIN voltage to drop below the recommended minimum voltage for the battery. Repeatedly discharging Li-Ion batteries in this manner can damage the long-term performance of the battery. Furthermore, providing excessive current into the load at the output terminal can cause voltage spikes on VOUT which could potentially overvoltage circuits connected to the VOUT terminal. To prevent the battery voltage from discharging below the recommended minimum voltage level, the present embodiment also includes an ODC circuit (320). This circuit will be activated to open the PMOS switch to disconnect the battery on the VIN terminal from the load on the VOUT terminal thereby ensuring that the battery voltage cannot be further discharged below its allowed minimum. A further protection is added in the current embodiment to protect the battery from accidental discharge during assembly into the battery system. This protection involves placing the Enable circuit (310) at the VOUT terminal. In this way, the PMOS switch is always in the off position unless the voltage on the VOUT terminal is raised above the voltage on the VIN terminal by a suitable threshold voltage. This allows the battery to be connected to the VIN terminal without any load being present. The methodology for energizing the PMOS switch is to connect the battery charger to the VOUT terminal of the protection IC, shown in FIG. 4, to raise the VOUT voltage higher than the battery voltage on the VIN terminal since the battery charger voltage is typically 5V, whereas the LI-Ion battery voltage is generally in the range of 3.9V˜4.2V.

A further embodiment of the present invention is shown in FIG. 7. In this embodiment, an additional protection system is added into the switch control block (30), the Over Current Control (OCTC) detection (330). With OCTC, the PMOS switch (20) can be opened to prevent excessive currents from the VIN terminal to the VOUT terminal. Such excessive currents could be caused either by a short to ground at the VOUT terminal or a malfunctioning circuit subsystem that is connected to the VOUT terminal. In either case, the over current condition can be detected, and the switch opened thereby preventing further damage to either the load circuitry or to the battery on the VIN terminal.

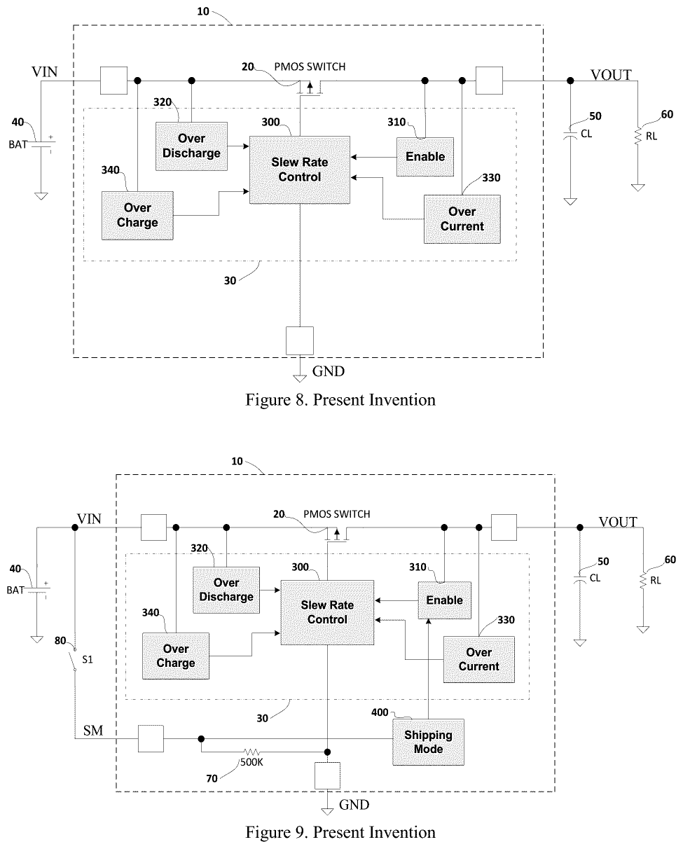

A further embodiment of the present invention is shown in FIG. 8 with the addition of an Overcharge Control (OCC) detection circuit (340). Once again, it is the object of the overcharge detection system to ensure that during the charging of the battery (40) by the battery charger which is connected to the VOUT terminal (FIG. 4), will not exceed the maximum designated voltage set for the battery type. For Li-Ion batteries that maximum voltage is around 4.4V-4.5V. Since the overcharge detection circuit is connected to the VIN terminal, which is also connected to the battery, the battery voltage can be monitored directly. Should an overcharge voltage (OCV) condition be found, the overcharge detection system will signal the PMOS switch (20) to open and thus terminate the battery charging cycle. To prevent any false triggering of the overcharge circuitry, a detection delay is included in the circuit. The delay time used depends on the battery type being used in the application; however, typical delay times for the overcharge detection system for Li-Ion batteries are in the 500 us-800 us time range.

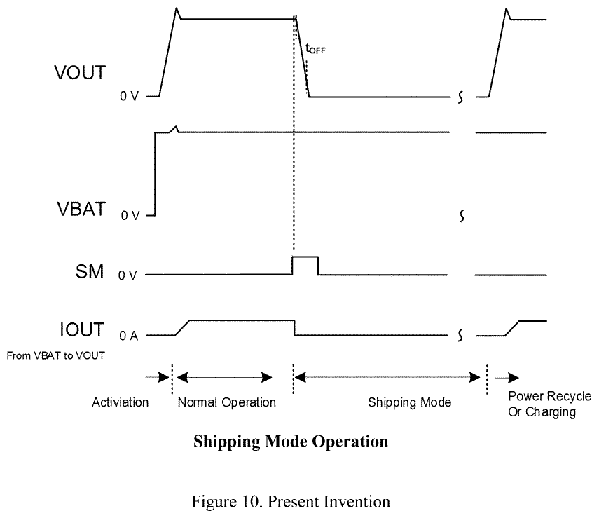

A further embodiment of the present invention is shown in FIG. 9 with the addition of a Shipping Mode (SM) function (400). It is the object of the SM function to control the enable/disable feature of the battery protection IC by means of an external push button switch (80) or to give a positive pulse on the SM pin, and the pulse width should be longer than a specified time. As shown in FIG. 9, a simple push button switch S1 (80) can be connected to resistor (70) and the SM terminal of the device. When the button (80) connects VIN to the SM pin for a specified period (see FIG. 10), the shipping mode function will then place the PMOS switch (20) into an open position thereby disconnecting the battery from the system loads, that can fully cut off the charging and discharging path between battery and loads, then prevent a pre-charged battery capacity from discharging at all. At the meantime SM signal will let present invention itself going and placing the system into a deep sleep mode, thus there is nearly no load consuming any battery current. This action will remove all possible current leakage paths from the battery at the VIN terminal allowing the battery to retain its charged voltage for an indefinite period. This function can be used in the storage and shipment of the ultra-portable system allowing it to arrive at the user destination without a drained battery. The function of the shipping mode system can then be overcome by plugging the battery charger into the VOUT terminal as is shown in FIG. 4, thus energizing the Enable path (310) and restoring the system to full functionality.

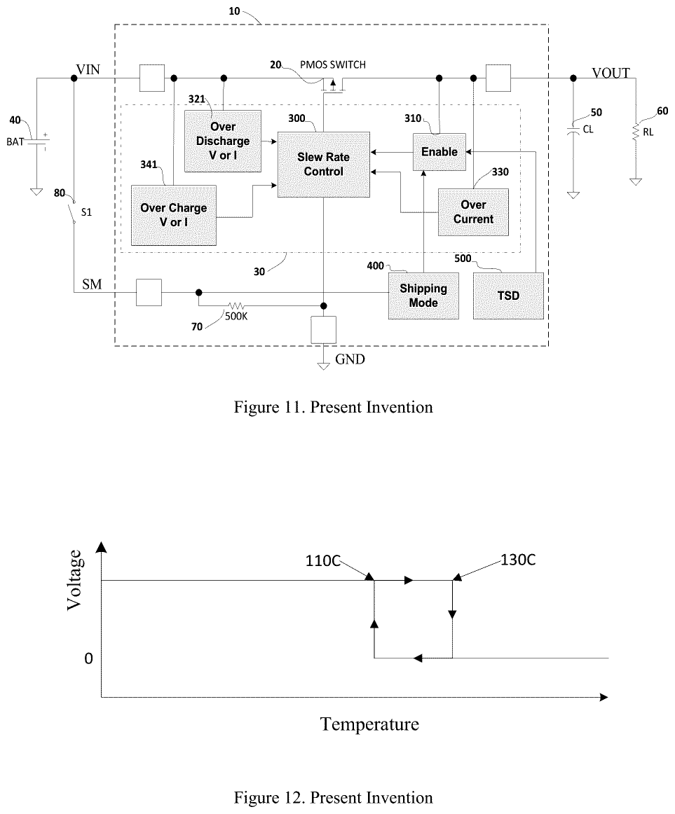

A further embodiment of the present invention is shown in FIG. 11 which introduces the capability of Overcharge Current (OCCT) detection in addition to Overcharge Voltage (OCV) detection (341) as well as the addition of Overdischarge Current (ODCT) detection to the Overdischarge Voltage (ODV) detection (321). The OCCT detection (341) allows the system to detect a dangerous current condition prior to the system reaching the OCV threshold and thereby protecting the battery from a dangerous current level. In a similar fashion, the ODCT detection (321) circuitry allows the system to protect the battery from a dangerous rapid discharge due to excessive current flow. In addition to the above battery protection measures, the embodiment introduces a Thermal Shutdown Detection (TSD) function (500). The TSD function continuously monitors the temperature of the IC and will open the PMOS switch (20) via the Enable block (310) should the die temperature exceed 130 C (see FIG. 12). The TSD will further monitor the temperature and re-enable the PMOS switch should the die temperature fall below 110 C.

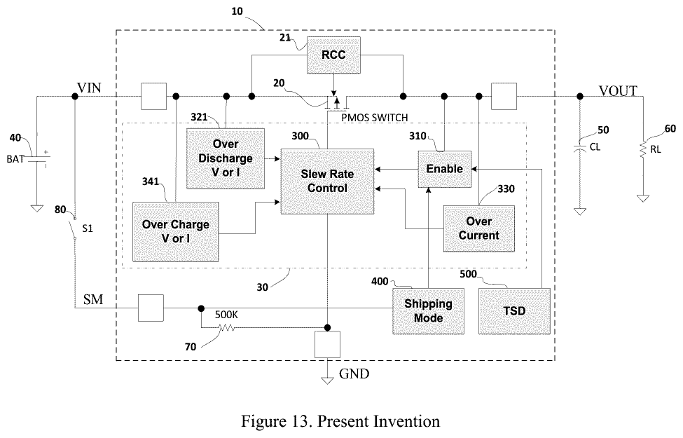

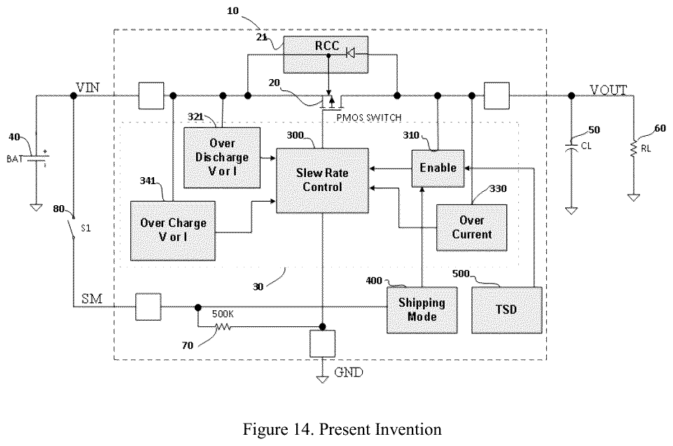

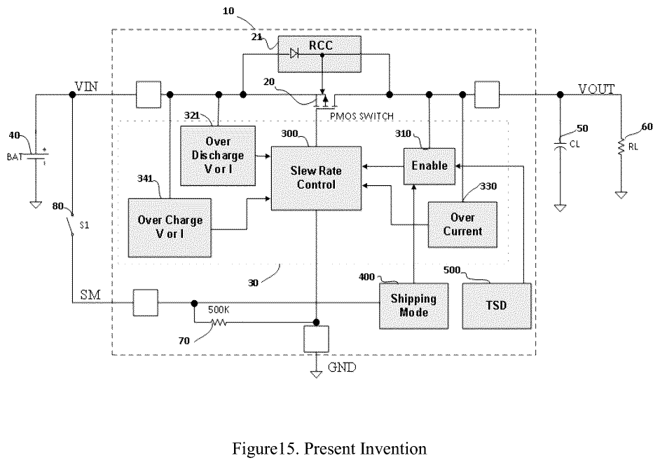

A further embodiment of the present invention is shown in FIG. 13. For this protection, a Reverse Current Control (RCC) block (21) is added to control the Bulk node of the PMOS device (20). Under normal charging conditions when the VIN voltage is greater than the Overdischarge Voltage (ODV) circuit level, the PMOS switch will be closed allowing the VIN pin to be connected to the VOUT pin so that the battery charger can charge the battery up to its desired voltage level. However, should the VIN voltage fall below the ODV threshold, the PMOS switch will be open to prevent any reverse current discharge of the battery. As shown in FIG. 14, there is a diode in the Reverse Current Control block (21) point from VOUT to VIN side, this diode can avoid battery current flow to load side and exhaust the battery, and it allow the current flow into the battery when the charger is once again applied to the VOUT pin. In the event that the battery voltage continues to be charged above the OCV level, the OCV protection will turn off the PMOS switch, and switch the bulk terminal connection to prevent more current to flow into the battery when the charger is applied to the VOUT pin all the time, at that time the diode in RCC will point from VIN to VOUT side shown in FIG. 15. This is the function of the RCC block. Thus, depending on the system conditions, the RCC block can be configured to either block reverse current or to allow reverse current.

The present invention includes a method of saving battery energy as described. In prior art, Vout delivers voltage if the battery connects with system. In present invention, Vout does not have any value until another extra voltage (>3.6V) applies to Vout like a charger. This feature can extend battery life dramatically for warehouse storage and shipping, especially long-time shipping.

1. A protection circuit comprising
a. an input pin VIN, connected to a battery;
b. an output pin VOUT, connected to an external load;
c. a ground pin GROUND/GND;
d. a PMOS switch comprising a PMOS transistor having
i. a PMOS gate;
ii. a PMOS source, connected to the VIN pin; and
iii. a PMOS drain, connected to the VOUT pin;
e. a switch control circuit comprising
i. a first input, connected to the input pin VIN;
ii. a second input, connected to the output pin VOUT; and
iii. an output, connected to the PMOS gate; and
f. a reverse current control (RCC) circuit automatically reconfigurable for the protection circuit to operate either at a safe power supplying mode to an external load or at a safe charging mode to the battery allowing the protection circuit to be able to begin charging when the PMOS power switch is in its OFF state.

2. The protection circuit of claim 1 wherein the switch control circuit comprises
i. a slew rate control circuit comprising
a. a first input;
b. a second input;
c. a third input;
d. a fourth input;
e. an output, connected to the PMOS gate;
ii. an enable control circuit comprising
a. an input, connected to the VOUT pin;
b. an output, connected to the first input of the slew rate control circuit;
c. a function that allows the slew rate control circuit to connect or disconnect the PMOS switch based upon the VOUT voltage being greater than the VIN voltage by a predetermined threshold voltage; and
iii. an ODC circuit comprising
a) an input connected to the VIN pin and
b) an output connected to the second input of the slew rate control-circuit
c) a function that allows the ODC circuit to override the VIN to VOUT connection of the PMOS switch such that it turns off the PMOS switch should a voltage at the VIN pin fall below a predetermined minimum battery voltage.

3. The protection circuit of claim 1 wherein the switch control circuit further comprises an over current detection circuit/system comprising
a. an input connected to the VOUT pin;
b. an output connected to the third input the slew rate control function; and
c. a function that allows the over current control (OCTC) circuit to override the VIN to VOUT connection of the PMOS switch should an output current as measured on the VOUT pin exceed a predetermined current value.

4. The protection circuit of claim 1 wherein the switch control circuit further comprises an overcharge detection control circuit comprising
a. an input connected to the VIN pin;
b. an output connected to the fourth input of the slew rate control function; and
c. a function that allows the overcharge control (OCC) circuit to override the VIN to VOUT connection of the PMOS switch should a voltage on the VIN pin exceed a predetermined maximum voltage level after a specific timing interval.

5. The protection circuit of claim 1 wherein the switch control circuit further comprises a shipping mode control circuit comprising
a. a shipping-mode SM (SM) pin;
b. a push button switch connected to the SM pin;
c. a switch S1 connected between the VIN pin and the SM pin;
d. a resistor of around 500K Ohm between the SM pin and the GND pin;
e. a first output connected to the enable control function; and
f. a shipping mode function allowing the enable circuit to turn off the PMOS switch after a predetermined delay time which is established by connecting the SM pin to VIN through the switch S1.

6. The protection circuit of claim 1 wherein the switch control circuit further comprises an overdischarge current control (ODCTC) circuit in addition to the overdischarge voltage (ODV) circuit comprising
a. an input connected to the VIN pin; and
b. an output connected to the fifth input of the slew rate control function and
c. a function that allows the overdischarge voltage (ODV) circuit to override the VIN to VOUT connection of the PMOS switch should a current on the VIN pin exceed a predetermined maximum safe current level.

7. The protection circuit of claim 1 wherein the switch control circuit further comprises an overcharge current (OCCT) circuit in addition to the overcharge voltage (OCV) circuit comprising
a. an input connected to the VIN pin; and
b. an output connected to the slew rate control function,
c. a function that allows the overcharge current control (OCCTC) to override the VIN to VOUT connection of the PMOS switch should the current on the VIN pin exceed a predetermined maximum safe current level.

8. The protection circuit of claim 1 wherein the switch control circuit further comprises a thermal shutdown circuit connected to the enable control circuit capable of opening the PMOS power switch by detecting an over temperature condition.

9. The protection circuit of claim 1 wherein the RCC comprises
a. a first input that is connected to the VIN pin;
b. a second input that is connected to the VOUT pin; and
c. an output that is connected to a circuit which allows the RCC to reconfigure the PMOS switch to have its body terminal connection be either connected to the VIN pin or the VOUT pin to allow or to prevent a current flowing from the VOUT pin to the VIN pin;
d. a circuit allowing the protection circuit to be able to begin charging when the PMOS power switch is in its OFF state.

10. A method for protection circuits to conserve energy stored in batteries connected with devices as loads of the batteries, especially being stored and/or being shipped, comprising having a shipping mode control circuit in the protection circuits, wherein the shipping mode control circuit comprises
a) an input pin SM;
b) a switch, S1, which is connected between the VIN pin and the SM pin;
c) a function that allows the shipping mode control circuit to be responsive to a single or multiple presses of the push button switch that will determine whether the PMOS switch shall remain open or closed to save the battery power; and
d) a resistor of around 500K Ohm between the SM pin and the GND pin.

11. The method of claim 10 wherein it comprises a way of keeping VOUT to be zero volts until a voltage (>3.6V) is applied to VOUT pin such as a battery charger and performing
i. Initial system power on: When the system is first connected to the battery, it will be off and the battery will be required to be charged. A battery charger can be connected with a voltage on the VOUT pin which is greater than the initial battery voltage on the VIN pin. This will activate the Enable function and connect the PMOS switch between VIN and VOUT allowing the battery charger to charge the battery to its full potential;
ii. System Power down: After the initial system charging, the battery charger is removed and now the battery on the VIN pin supplies the energy to power the system through the PMOS switch which remains connecting VIN to VOUT. In order to save the battery's energy for either storage or shipment of the unit, the system needs to disconnect from the battery. This is accomplished via the push button switch S1 connected to the SM input pin. Pressing the push button for a specified period, say 5 seconds, then activates the shipping mode function causing the shipping mode circuit to override the VIN to VOUT connection of the PMOS switch and disconnect the output system from the battery thus allowing the voltage on the VOUT pin to discharge to zero volts; and
iii. System Re-energize: After a prolonged storage or shipment, the system is re-activated by once again attaching the battery charger to the VOUT pin and causing the enable function to activate the PMOS switch once again to connect the VIN pin to the VOUT pin. This re-activation allows the charger to again charge the battery back up to full in a much shorter time since the amount of battery discharge during storage and shipment has been greatly reduced by using the shipping mode function.
